(19) United States
(12) Patent Application Publication
(10) Pub. No.: US 2015/0050518 A1
(43) Pub. Date: Feb. 19, 2015

(54) METHOD AND COMPOSITION FOR PASSIVATING ZINC, ZINC-COATED, SILVER, AND SILVER-COATED SUBSTRATES

(71) Applicant: Sanchem, Inc., Chicago, IL (US)

(72) Inventor: John W. Bibber, Chicago, IL (US)

(73) Assignee: Sanchem, Inc., Chicago, IL (US)

(21) Appl. No.: 13/967,692

(22) Filed: Aug. 15, 2013

(51) Int. Cl. C09D 5/08; C23C 28/00

(52) U.S. Cl. CPC C09D 5/08; C23C 28/34; C23C 28/32
USPC 428/628; 427/435; 427/419.2; 428/469

(57) ABSTRACT

A method to inhibit corrosion of a substrate. The method includes the steps of contacting a metallic substrate with an aqueous solution comprising permanganate ions and silicate ions, for a time and a temperature sufficient to deposit a corrosion-inhibiting coating on the metallic substrate.

### BACKGROUND

Zinc is often coated onto iron or steel substrates in order to prevent the corrosion of the iron or steel article in question. The process, long known as galvanization, is desirable because the non-structural zinc coating corrodes in preference to the structural iron or steel substrates. Thus, galvanization is the process of applying a protective zinc coating to a substrate, typically a steel or iron substrate, in order to prevent the substrate from rusting. The term is derived from the name of Italian scientist Luigi Galvani. Galvanization can be accomplished via electrochemical and electrodeposition processes. However, the most common method in current use is hot-dip galvanization, in which the substrate to be Zn-coated is submerged in a bath of molten zinc.

During the process of corroding, the zinc will leave behind a soft, powdery, white residue. Once the zinc coating is entirely corroded, it no longer protects the underlying substrate from corroding. In order to increase the overall level of corrosion protection and to prevent the white powdery residue from forming, zinc-coated iron and steel articles have been further treated with chromates or Cr³⁺ (i.e., trivalent chromium) solutions. These solutions are coated onto the galvanized substrate and then spontaneously oxidize into Cr⁶⁺ coatings (i.e., hexavalent chromium coatings) once exposed to moisture and oxygen. The European Union (“EU”) no longer permits the use of hexavalent chromium on zinc-coated articles due to concerns over environmental toxicity of the chromium coatings. Similarly, the use of hexavalent and trivalent coatings is also currently being phased out in the United States and Canada.

To date the most effective alternative process to using chromium-containing coatings has been to activate the zinc with an acid solution and then passivate the zinc with a permanganate solution before sealing the surface with a silicate solution. See, for example, U.S. Patent Publication 2005/0181137 to Straus (published Aug. 18, 2005). However, in the process described by Straus, the surface of the zinc takes on a yellow color which in many cases is not desirable, and in some cases simply unacceptable in the market. In addition, the process is laborious. It requires using an acid to activate the surface of the zinc, rinsing the surface, applying a permanganate solution within a defined pH range, rinsing again to remove excess permanganate, applying a silicate-based sealing solution, and rinsing yet again. This is an involved and complicated process for use in industrial settings (where simplicity and speed are often keys to attaining profitability).

Similar to iron and steel substrates, silver, silver alloys and silver-plated articles are attacked by sulfur compounds in the air and in many foods, turning the silver a dark grey or black in color due to the formation of silver sulfides. The process is trivially known as tarnishing. In order to prevent this discoloration with little loss of brightness and reflectivity, a very thin film of chromium VI oxides has been used for well over fifty years. See, for example, Dettner, H. W. “Jahrbuch der Oberflächentechnik” [“Surface Technologies Yearbook”], 13, 158; © 1958 Metall-Verlag press. See also German Patent DE 592,710 to Jakob Spanner and assigned to Finckh GmbH (Feb. 13, 1934), titled “Verfahren zur Verhuetung des Anlaufens von Silbernen oder Versilberten Gegenstaenden” [“A Method for Preventing the Tarnishing of Silver or Silver-Plated Objects”]. Because chromium VI compounds are known cancer-causing agents, there has been a long sought but unmet need for a safe and environmentally friendly passivating process.

### SUMMARY

Disclosed herein is a process that significantly reduces the number of processing steps and greatly increases the efficiency and overall effectiveness of the passivating process for zinc-plated substrates, as well as for silver, its alloys, and substrates coated with silver and its alloys.

The process comprises contacting a zinc substrate, a zinc-coated substrate, a silver substrate, a silver-containing substrate, or a substrate coated with silver or a silver-containing allow with a solution (preferably aqueous) comprising a soluble silicate and a soluble permanganate for a time and a temperature wherein a passivating coating is deposited on the substrate. Potassium silicate is the preferred silicate; potassium permanganate is the preferred permanganate. Also included within the claims is a substrate that has been treated by the process. The process yields a highly passivated, corrosion-resistant and clear coating on zinc and silver items, and zinc-coated and silver-coated substrates.

Any silicate and permanganate compound which is at least slightly soluble can be used in the process. Among suitable silicates are sodium silicate (Na₂SiO₃), potassium silicate (K₂SiO₃), and the like. Permanganate is the general name for a chemical compound containing the permanganate(VII) ion, MnO₄⁻. Because manganese atom is in the +7 oxidation state, the permanganate ion is a strong oxidizing agent. A non-exclusive list of suitable permanganate compounds that can be used in the process include ammonium permanganate (NH₄MnO₄), calcium permanganate (Ca(MnO₄)₂), barium permanganate (Ba(MnO₄)₂), potassium permanganate (KMnO₄), sodium permanganate (NaMnO₄), silver permanganate (AgMnO₄), and the like. Permanganates and silicates are common commercial chemicals, widely available from a host of national and international suppliers.

The preferred lower limit on the permanganate concentration is about 0.001 M and the preferred lower limit on the silicate concentration is about 0.1 M. These are simply preferred and concentrations lower than these are explicitly within the scope of the present disclosure. The upper limits of the permanganate and silicate concentrations will be the saturation point of solubility for the chemicals being used at the temperature at which the process is conducted. Once applied, the coating may be fully cured by briefly heating to about 300° F. or higher or allowing the treated article to sit overnight at ambient temperatures before being put into service.

As used herein, “substrate” means any material, metallic or otherwise, susceptible to the passivation technique described herein or a non-susceptible material coated with susceptible material. “Substrate” includes zinc and its alloys, iron and its alloys, silver and its alloys, aluminum and its alloys, titanium and its alloys, magnesium and its alloys, etc.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 1 to 9, from 3.6 to 4.6, from 3.5 to 9.9, and so forth.

All references to singular characteristics or limitations of the present invention shall include the corresponding plural characteristic or limitation, and vice-versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The methods of the present invention can comprise, consist of, or consist essentially of the essential elements and limitations of the method described herein, as well as any additional or optional ingredients, components, or limitations described herein or otherwise useful in metallic coating chemistry.

### EXAMPLES

The following examples will illustrate the process when used on freshly “hot-dip” galvanized three inch by five inch 1010 cold-rolled steel panels and when used on freshly electrodeposited three inch by five inch 1010 cold-rolled steel panels. Unless otherwise noted, potassium silicate and potassium permanganate were used to supply the silicate and permanganate ions.

### Example 1

### Hot Treatment, Hot-Dip Galvanized, Standard

A freshly hot-dip galvanized 1010 alloy steel panel, while still at 310° F., was dipped into a mineral-free water solution of 2.2 grams per liter permanganate and 33.0 grams per liter of silicate for five seconds, removed and allowed to dry. The metallic, zinc-colored panels were then cooled to ambient temperatures. The panels were found to have a uniform, 0.0005 inch-thick coating of zinc metal. The panels were placed in a neutral salt spray cabinet according to ASTM specification B117 and were subjected to a continuous salt spray. The panels endured 154 hours in the salt spray before showing any signs of white corrosion. This duration far exceeds the corrosion requirements of 120 hours specified by General Motors in its specification GMW 3044. The 154 hour duration also exceeds the ASTM B 201 specification for clear or metallic-colored chromate-based coating systems on zinc.

### Example 2

### Electrodeposited, Hot, Standard Procedure

A 0.0003 inch-thick coating of zinc was electrodeposited on a 1010 alloy steel panel which was then rinsed in mineral-free water and placed in a solution of 2.2 grams per liter permanganate and 33.0 grams per liter silicate for five seconds, removed and dried with hot air at 350° F. The metallic, zinc-colored panels were then cooled to ambient temperatures and placed in a neutral salt spray cabinet according to ASTM specification B117. The panels showed no signs of white corrosion after 150 hours of exposure. This far exceeds the General Motors specification GMW 3044, the ASTM B 201 specification, and the ASTM B 633 specifications for electrodeposited clear zinc chromate panels.

### Example 3

### Hot-dip Galvanized, Ambient Temperature, Standard Procedure

A freshly hot-dip galvanized 1010 alloy steel panel was cooled to ambient temperature and briefly cleaned in a mild alkaline cleaner to remove any loose surface oxides. The panel was then dipped into a mineral-free water solution of 2.2 grams per liter permanganate and 33.0 grams per liter of silicate for five seconds, removed and allowed to dry. The metallic zinc-colored panels were then allowed to sit for 48 hours before being placed in a neutral salt spray cabinet according to ASTM specification B117. The panels had a 0.0005 inch-thick coating of zinc metal and went 154 hours before showing any signs of white corrosion. This far exceeds the corrosion requirements of 120 hours as specified in “General Motors” specification “GMW 3044” and the “ASTM B 201” specification for clear or metallic colored Chromate based coating systems on zinc.

### Example 4

### Lower Limit Permanganate, Hot-dip Galvanized, Hot

A freshly hot-dip galvanized 1010 alloy steel panel, while still at 310° F., was dipped into a mineral-free water solution of 0.12 grams per liter permanganate and 33.0 grams per liter of silicate for five seconds, removed, and allowed to dry. The metallic zinc-colored panels were then cooled to ambient temperatures and placed in a neutral salt spray cabinet according to ASTM specification B117. The panels had a 0.0005 inch-thick coating of zinc metal and endured 43 hours in the salt spray before showing any signs of white corrosion. This did not meet the corrosion requirements of 120 hours as specified in General Motors specification GMW 3044.

### Example 5

### Electrodeposited, Lower Limit Silicate

A 0.0003 inch-thick coating of zinc was electrodeposited on a 1010 alloy steel panel which was then rinsed in mineral-free water and placed in a solution of 2.2 grams per liter permanganate and 7.6 grams per liter silicate for five seconds, removed, and dried with hot air at 350° F. The metallic zinc-colored panels were then cooled to ambient temperatures and placed in a neutral salt spray cabinet according to ASTM specification B117. The panels showed signs of white corrosion after 45 hours of exposure. This did not meet the General Motors specification GMW 3044.

### Example 6

### Low Permanganate Concentration, Electrodeposited

A 0.0003 inch-thick coating of zinc was electrodeposited on a 1010 alloy steel panel which was then rinsed in mineral-free water and placed in a solution of 0.2 grams per liter permanganate and 33.0 grams per liter silicate for five seconds, removed, and dried with hot air at 350° F. The metallic zinc-colored panels were then cooled to ambient temperatures and placed in a neutral salt spray cabinet according to ASTM specification B117. The panels showed no signs of white corrosion after 132 hours of exposure. This result exceeds the General Motors specification GMW 3044, the ASTM B201 specification, and the ASTM B633 specification for electrodeposited clear zinc chromate panels.

### Example 7

### Electrodeposited, Low Silicate Concentration

A 0.0003 inch-thick coating of zinc was electrodeposited on a 1010 alloy steel panel which was then rinsed in mineral-free water and placed in a solution of 2.2 grams per liter permanganate and 7.8 grams per liter silicate for five seconds, removed, and dried with hot air at 350° F. The metallic zinc-colored panels were then cooled to ambient temperatures and placed in a neutral salt spray cabinet according to ASTM specification B117. The panels showed signs of white corrosion after 125 hours of exposure. This exceeds the General Motors specification GMW 3044, the ASTM B201 specification, and the ASTM B633 specification for electrodeposited clear zinc chromate panels.

### Example 8

### 24-Hour Ambient Drying

A 0.0003 inch-thick coating of zinc was electrodeposited on a 1010 alloy steel panel which was then rinsed in mineral-free water and placed in a solution of 2.2 grams per liter permanganate and 33.0 grams per liter silicate for five seconds, removed, and dried 24 hours. The metallic, zinc-colored panels were then cooled to ambient temperature and placed in a neutral salt spray cabinet according to ASTM specification B117. The panels showed signs of white corrosion after 140 hours of exposure. This exceeds the General Motors specification GMW 3044, the ASTM B201 specification, and the ASTM B633 specification for electrodeposited clear zinc chromate panels.

### Example 9

### Dipping at 310° F.

A freshly hot-dip galvanized 1010 alloy steel panel, while still at 310° F., was dipped into a mineral-free water solution of 2.2 grams per liter permanganate and 33.0 grams per liter of silicate for five seconds, removed, and allowed to dry. Here, sodium silicate and sodium permanganate were used. The metallic zinc-colored panels were then cooled to ambient temperatures and placed in a neutral salt spray cabinet according to ASTM specification B117. The panels had a 0.0005 inch-thick coating of zinc metal and endured 154 hours before showing any signs of white corrosion. This far exceeds the corrosion requirements of 120 hours as specified in General Motors specification GMW 3044 and the ASTM B201 specification for clear or metallic-colored chromate based coating systems on zinc.

### Example 10

### Hot-Dip into Saturated Solution

A freshly hot-dip galvanized 1010 alloy steel panel, while still at 325° F., was dipped into a mineral-free water saturated solution of permanganate and of silicate for five seconds, removed, and allowed to dry. The metallic zinc-colored panels were then cooled to ambient temperatures and placed in a neutral salt spray cabinet according to ASTM specification B117. The panels had a 0.0005 inch-thick coating of zinc metal and went 156 hours before showing any signs of white corrosion. This far exceeds the corrosion requirements of 120 hours as specified in General Motors specification GMW 3044 and the ASTM B201 specification for clear or metallic-colored chromate-based coating systems on zinc.

The following examples illustrate the tarnish resistance imparted to silver, silver alloys and/or silver-plated articles using the disclosed process.

### Example 11

### Standard Procedure

A clean, oxide-free one inch by two inch pure silver panel that was 0.0625 inches thick was dipped into a 2.2 gram per liter solution of permanganate containing 33.0 grams of silicate at a pH of 11.5 for five seconds, removed. dried at ambient temperature, and left undisturbed for 24 hours. The panel was then placed in a 5 wt % sodium sulfide solution at ambient temperatures for five minutes. No silver sulfide staining developed.

### Example 12

### No Silicate Present

A clean, oxide-free one inch by two inch pure silver panel that was 0.0625 inches thick was dipped into a 2.2 gram per liter solution of permanganate at a pH of 11.5 for five seconds, removed, dried at ambient temperatures, and left undisturbed for 24 hours. The panel was then placed in a 5 wt % sodium sulfide solution at ambient temperatures for thirty seconds. The panel was completely covered with silver sulfide.

### Example 13

### No Permanganate Present

A clean, oxide-free one inch by two inch pure silver panel that was 0.0625 inches thick was dipped into a 33.0 gram per liter solution of silicate at a pH of 11.5 for five seconds, removed, dried at ambient temperatures, left undisturbed for 24 hours. The panel was then placed in a 5 wt % sodium sulfide solution at ambient temperatures for thirty seconds. The panel was completely covered with silver sulfide.

### Example 14

### Upper Limits

A clean, oxide-free one inch by two inch pure silver panel that was 0.0625 inches thick was dipped into a saturated solution of permanganate saturated with silicate at a pH of 11.8 for five seconds, removed, dried at ambient temperatures, and left undisturbed for 24 hours. The panel was then placed in a 5 wt % sodium sulfide solution at ambient temperatures for five minutes. No silver sulfide staining developed.

### Example 15

### Lower Limits, Permanganate

A clean, oxide-free one inch by two inch 90% silver, 10% copper panel that was 0.12 inches thick was dipped into a 0.12 gram per liter solution of permanganate containing 33.0 grams of silicate at a pH of 11.5 for five seconds, removed, dried at ambient temperature, and left undisturbed for 24 hours. The panel was then placed in a 5 wt % sodium sulfide solution at ambient temperatures for five minutes. The panel developed a light brown color.

### Example 16

### Lower Limits, Silicate

A clean, oxide-free one inch by two inch pure silver panel that was 0.0625 inches thick was dipped into a 2.2 gram per liter solution of permanganate containing 7.6 grams of silicate at a pH of 11.0 for five seconds, removed, dried at ambient temperatures, and left undisturbed for 24 hours. The panel was then placed in a 5 wt % sodium sulfide solution at ambient temperatures for five minutes. The panel developed a light gray color.

### Example 17

### Lower Limits

A clean, oxide-free one inch by two inch pure silver panel that was 0.0625 inches thick was dipped into a 0.12 gram per liter solution of permanganate containing 7.6 grams of silicate at a pH of 11.0 for five seconds, removed, dried at ambient temperature, and left undisturbed for 24 hours. The panel was then placed in a 5 wt % sodium sulfide solution at ambient temperatures for five minutes. The panel developed a dark gray color.

### Example 18

### Silver-Plated Substrate

A clean, oxide-free, one inch by two inch by 0.125 inch pure copper panel plated with 0.005 inches of pure silver and was dipped into a 2.2 gram per liter solution of permanganate containing 33.0 grams of silicate at a pH of 11.5 for five seconds, removed, dried at ambient temperature, and left undisturbed for 24 hours. The panel was then placed in a 5 wt % sodium sulfide solution at ambient temperatures for five minutes. No silver sulfide staining developed.

What is claimed is:

1. A method to inhibit corrosion of a substrate, the method comprising contacting a metallic substrate with an aqueous solution comprising permanganate ions and silicate ions, for a time and a temperature sufficient to deposit a corrosion-inhibiting coating on the metallic substrate.

2. The method of claim 1, wherein the aqueous solution comprises at least 0.001 M permanganate and 0.1 M silicate.

3. The method of claim 1, wherein the permanganate is provided by potassium permanganate or sodium permanganate and the silicate is provided by potassium silicate or sodium silicate

4. The method of claim 1, comprising contacting a metallic substrate comprising zinc, or a zinc-coated substrate, with the aqueous solution.

5. The method of claim 4, wherein the aqueous solution comprises at least 0.001 M permanganate and 0.1 M silicate.

6. The method of claim 4, wherein the permanganate is provided by potassium permanganate or sodium permanganate and the silicate is provided by potassium silicate or sodium silicate

7. The method of claim 1, comprising contacting a substrate comprising a zinc-coated steel article with the aqueous solution.

8. The method of claim 7, wherein the aqueous solution comprises at least 0.001 M permanganate and 0.1 M silicate.

9. The method of claim 7, wherein the permanganate is provided by potassium permanganate or sodium permanganate and the silicate is provided by potassium silicate or sodium silicate

10. The method of claim 1, comprising contacting a metallic substrate comprising silver, or a silver-coated substrate with the aqueous solution.

11. The method of claim 10, wherein the aqueous solution comprises at least 0.001 M permanganate and 0.1 M silicate.

12. The method of claim 11, wherein the permanganate is provided by potassium permanganate or sodium permanganate and the silicate is provided by potassium silicate or sodium silicate.

13. The method of claim 1, comprising contacting the metallic substrate with the aqueous solution at a temperature of from about 50° F. to about 400° F.

14. The method of claim 13, wherein the aqueous solution comprises at least 0.001 M permanganate and 0.1 M silicate.

15. The method of claim 13, wherein the permanganate is provided by potassium permanganate or sodium permanganate and the silicate is provided by potassium silicate or sodium silicate.

16. The method of claim 1, comprising contacting the metallic substrate with the aqueous solution at a temperature of from about 70° F. to about 350° F.

17. The method of claim 16, wherein the aqueous solution comprises at least 0.001 M permanganate and 0.1 M silicate.

18. The method of claim 16, wherein the permanganate is provided by potassium permanganate or sodium permanganate and the silicate is provided by potassium silicate or sodium silicate.

19. A coated substrate produced by contacting a metallic substrate with an aqueous solution comprising permanganate ions and silicate ions, for a time and a temperature sufficient to deposit a corrosion-inhibiting coating on the metallic substrate.
